(19) United States
(12) Patent Application Publication
(10) Pub. No.: US 2023/0363962 A1
(43) Pub. Date: Nov. 16, 2023

(54) AUTOMATED PATIENT TURNER SYSTEM

(71) Applicants: Sabyasachi Bain, Vienna, VA (US); Mangala G. Kuppa, Vienna, VA (US)

(72) Inventors: Sabyasachi Bain, Vienna, VA (US); Mangala G. Kuppa, Vienna, VA (US)

(21) Appl. No.: 17/663,245

(22) Filed: May 13, 2022

(51) Int. Cl. A61G 7/00; A61G 7/05

(52) U.S. Cl. CPC A61G 7/001; A61G 7/0507; A61G 2200/32; A61G 2203/36

(57) ABSTRACT

A patient turner system is herein disclosed. The system is used in unison with a patient bed to facilitate turning of a patient lying in the bed. The turner system generally includes a base frame, a pair of posts, a pair of bearings that move along the posts, a pair of actuators for moving the bearings, and at least one controller for selectively operating the pair of actuators. A sheet is coupled with the pair of bearings such that movement of the bearings adjusts a position of the sheet to turn a patient in the patient bed.

### BACKGROUND OF THE INVENTION

The present invention relates to immobile patients and, more particularly, to an automated patient turner that changes the lateral lying position of a person.

Fluid accumulation in the lungs and bedsores are common conditions among immobile patients. These issues develop when a patient is immobilized in the same position for prolonged periods of time. Aside from the discomfort to the patient, pressure sores are difficult and costly to treat. They can become infected and, in severe situations, may even lead to the death of the patient.

These conditions are preventable if the position is turned or repositioned periodically. However, manually turning a patent is labor and time-intensive. Care giver sleep deprivation is also a substantial burden that the patient families face when having to manually turn the patient throughout the night. As can be seen, there is a need for an automated system for turning immobile patients in bed.

### SUMMARY OF THE INVENTION

In one aspect of the present invention, a patient turner system is provided and comprises: a base frame configured to be positioned proximal a base of a patient bed; a first post coupled to a first side of the base frame, the first post comprising a first track; a second post coupled to a second side of the base frame, the second post comprising a second track; a first bearing configured to move in the first track; a second bearing configured to move in the second track; a first actuator configured to move the first bearing; a second actuator configured to move the second bearing; a controller for selectively operating the first actuator and the second actuator; and a sheet coupled to the first bearing at a sheet first side and coupled to the second bearing at a sheet second side, wherein movement of the first bearing, the second bearing, or both the first bearing and the second bearing adjusts a position of the sheet.

In another aspect of the present invention, a patient turner system in combination with a patient bed is provided, with the patient turner system comprising: a base frame positioned proximal a base of the patient bed; a first post coupled to a first side of the base frame, the first post comprising a first track; a second post coupled to a second side of the base frame, the second post comprising a second track; a first bearing configured to move in the first track; a second bearing configured to move in the second track; a first actuator configured to move the first bearing; a second actuator configured to move the second bearing; a controller for selectively operating the first actuator and the second actuator; and a sheet coupled to the first bearing at a sheet first side and coupled to the second bearing at a sheet second side, wherein movement of the first bearing, the second bearing, or both the first bearing and the second bearing adjusts a position of the sheet.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a perspective view of an embodiment of the present invention, shown in use;

FIG. 2 is a perspective view of the embodiment of the present invention, showing actuation thereof;

FIG. 3 is an exploded view of the embodiment of the present invention;

FIG. 4 is a side view of the embodiment of the present invention, shown in use with a sheet in a first position;

FIG. 5 is a side view of the embodiment of the present invention, showing motion of a second linear bearing of the embodiment and the sheet in a second position; and

FIG. 6 is a side view of the embodiment of the present invention, showing motion of a first linear bearing of the embodiment and the sheet in a third position;

FIG. 7 is a flow chart of the embodiment of the present invention;

FIG. 8 is a detail view of the embodiment of the present invention, showing the attachment of adjustable tethers to a support bar and a linear bearing; and

FIG. 9 is a detail view of the embodiment of the present invention, showing the selective attachment of flexible attachments to the support bar.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details. For the purpose of clarity, technical material that is known in the technical fields related to the present invention has not been described in detail so that the present invention is not unnecessarily obscured

Broadly, one embodiment of the present invention is an automatic mechanical system that can either change the lateral lying position of an immobile patient automatically in various manners, such as at specific time intervals or using voice command. It will be appreciated that the term “patient”, as used, does not necessarily extend to individuals in a hospital or other health/center, but rather can also be applied to any individual who is required to lay in bed for a period of time. Prior to the present invention, there was no product in the market that could change lying position automatically or via voice command in the manner described herein. The present invention can be powered in any appropriate way, such as direct current power.

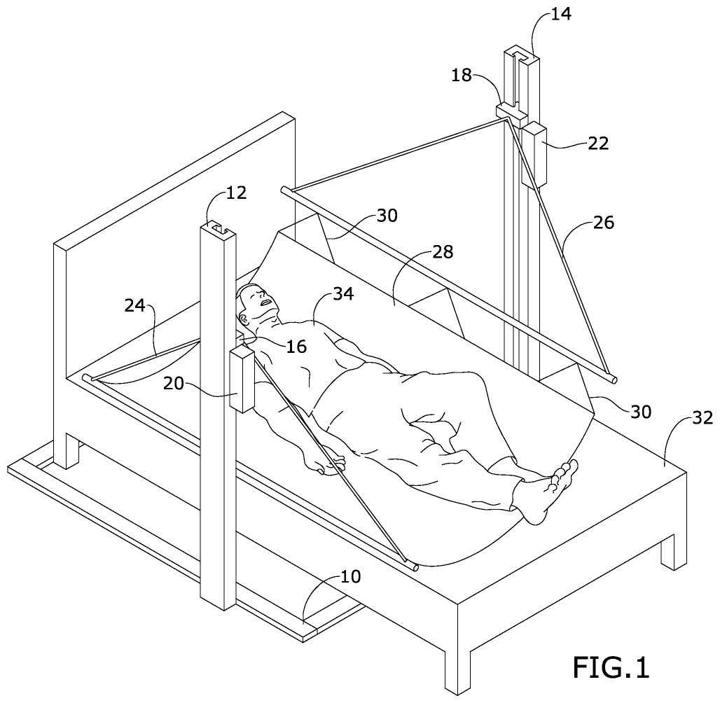

Referring now to FIG. 1, a patient turner includes a rectangular base frame 10 that serves as a support structure for a vertically extending first post 12 and an oppositely disposed vertically extending second post 14. The base frame is also designed such that it allows for a manual hydraulic lift (e.g., a HOYER™ lift) to get in under the bed 32 while still providing stability. The frame 10 can be laid on the floor or raised up on four legs. The base frame 10 is dimensioned such that the first post 12 and second post 14 are positioned on opposite sides of a bed 32. As shown in FIG. 1, the posts 12, 14 are positioned to remain outside of the bed 32 such that the bed 32 can independently be operated for vertical movement (e.g., adjustable/hospital beds currently available). Additionally, the posts 12, 14 are free-standing (i.e., not directly coupled to or supported by another structure at uppermost ends thereof), enabling other patient assisted devices (e.g., a HOYER™ lift) to operate.

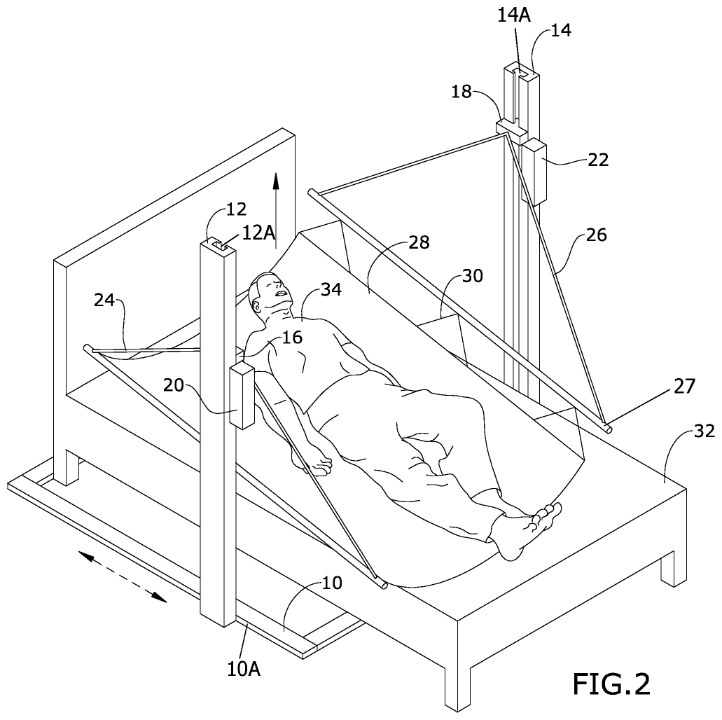

As depicted by the double-ended directional arrow in FIG. 2, the posts 12, 14 are slidably coupled to the base frame 10 such that they can be slid along a length of the bed 32 to adjust their relative position thereto. In certain embodiments, the posts 12, 14 may be slidable along tracks 10A defined in the base frame 10. Advantageously, this permits the posts 12, 14 to be slid toward the bed's headboard to allow sufficient clearance such that a patient 34 can be transferred into and out of the bed 32. This movement may be manually implemented or made automatic with the addition of a motor or actuator.

A first linear bearing 16 rides vertically in a first track 12A defined in the first post 12, and a second linear bearing 18 does the same in a second track 14A defined in the second post 14. These bearings 16, 18 are controlled by a first linear actuator 20 and a second linear actuator 22, respectively.

A microcontroller/controller is provided and programmed such that it can effect movement of linear actuators 20, 22 up and down. In certain embodiments, separate controllers can be provided for both linear actuators 20, 22. As those with skill in the art will appreciate, actuator movement can be preset for safety (e.g., ranges of movement of the actuators 20, 22 can be limited) via the controller so that patient can only turn laterally only to an extent. Further safety features can be implemented within the spirit and scope of the present invention. For example, the controller can be configured to prevent both linear actuators from being raised at the same time. It can be programmed in such a way that if one actuator 20 goes up, the other 22 will go down.

The controller(s) includes, for example, one or more microphones, a communication interface, and a processor with memory coupled thereto. This structure enables the controller(s) to receive, process, and execute commands transmitted in various forms, such as, but not limited to, voice input and wireless communication from a mobile computing device (e.g., a smartphone running systemic software thereon). This operation is described in greater detail below.

The controller of the present invention may include at least one computing device with a user interface operably associated therewith. The user interface may include any appropriate interface that permits communication between a person and the controller computing device. The controller computing device may include at least one processing unit coupled to a form of memory. The controller computing device includes a program product including a machine-readable program code for causing, when executed, the controller computing device to perform steps. The program product may include systemic software which may either be loaded onto the controller computing device or accessed by the computing. The loaded systemic software may include an application. The systemic software may also be accessed by the controller computing device using the internet, extranet, intranet, host server, internet cloud and the like.

Similarly, the mobile computing device of the present invention may include, but is not limited to, a desktop, laptop, and smart device, such as, a tablet and smart phone. The mobile computing device may include at least one processing unit coupled to a form of memory. The mobile computing device includes a program product including a machine-readable program code for causing, when executed, the mobile computing device to perform steps. The program product may include systemic software which may either be loaded onto the mobile computing device or accessed by the computing. The loaded systemic software may include an application loaded on a smart device. The systemic software may also be accessed by the mobile computing device using the internet, extranet, intranet, host server, internet cloud and the like.

The patient turner further includes a sheet 28 that, in use, is positioned below a patient 34 (who rests on the sheet). Being a separate sheet 28 from the bed 32, it allows the described system to work with any bed/mattress (adjustable bed or otherwise). Two sets of flexible attachments 30 are coupled, on opposing sides, to the sheet 28 (generalized as a first sheet side and a second sheet side). Each flexible attachment 30 has two attachment points to the sheet 28 and a single attachment point to a support rod 27. In certain embodiments, the support rods may be formed from metal. It will be appreciated that, in general, structure on the left and right side of the patient turner is mirrored such that the same functionality is achieved on both sides of the patient. Thus, where the description is directed towards, for example, “a support rod 27”, it is understood that this description corresponds to both the left and right sides of the patient turner.

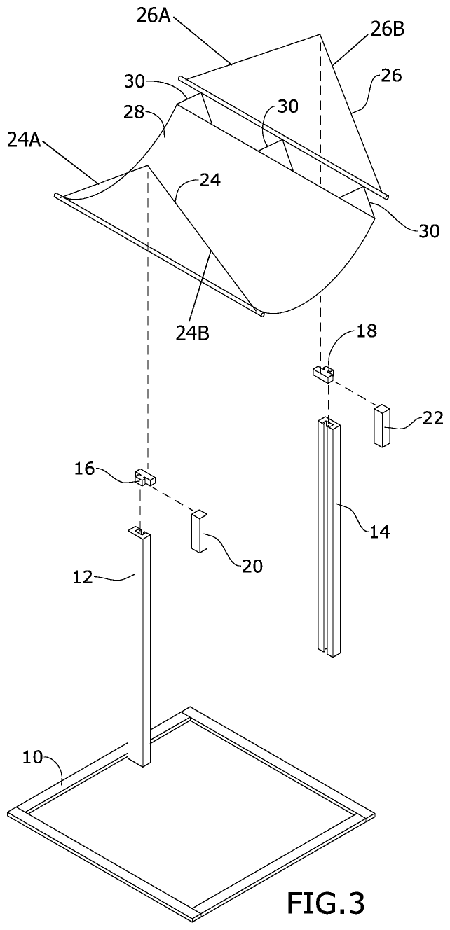

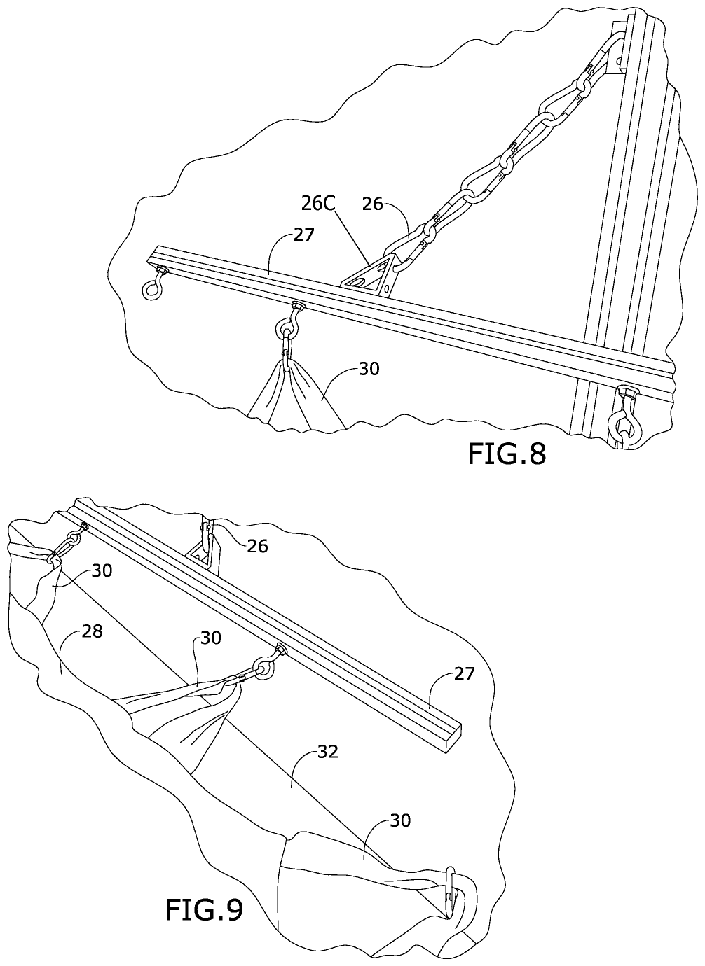

As shown in FIGS. 2 and 3, the support rods 27 are coupled to the bearings 16, 18 via a first tether 24 and a second tether 26, respectively. These tethers 24, 26 may each include two tether segments. Specifically, the first tether 24A may include a pair of first tether segments 24A and a pair of second tether segments 26A. Thus, the sheet 28 is indirectly coupled to the bearings 16, 18 by this aforementioned intermediate structure. As shown from FIGS. 1-2 (and FIG. 8), a length of the tethers 24, 26 on the left and right side of the bearings 16, 18 can be adjusted by individually adjusting the length of a respective segment 24A, 26A of the tethers 24, 26. By doing so, the sheet 28 can be tilted upwards to raise the upper body of the patient 34, as shown in FIG. 2, and lower the patient 34 back down to a horizontal position, as shown in FIG. 1. Those with skill in the art will appreciate that other configurations of length-adjustable tethers 24, 26 may be employed. For example, the tether segments 24A, 26A may be formed from links detachably connected to one another (such as carabiners as depicted in FIG. 8), or the tethers 24, 26 may be each formed from a pair of retractable cables.

As shown in FIGS. 8 and 9, many of these connections can be made as adjustable and detachable, providing more versatility for the end-user. For example, as shown in FIG. 8, a bracket 26C that connects the tether 26 to the support rod 27 can be provided in a manner that it is slidable in a groove along a length of the support rod 27 (and clampable or lockable thereto). As shown in FIG. 9, the flexible attachments 30 can be selectively detached from the support bar 27, if needed (e.g., see bottommost attachment 30 in FIG. 9). This can be achieved by any appropriate coupling, such as via a carabiner clipping onto a hook on the support rod 27 (as shown in FIG. 9). By way of example, if the last attachment 30 is removed at the leg end (e.g., FIG. 9), then only upper body can have a different incline position while the leg side does not incline. This allows more flexible body incline position than making the whole body inclined by adjusting the tether lengths.

As part of the overall system, and as mentioned above, the controller(s) may receive various forms of input (from a person) to control movement of the bearings 16, 18 via the actuators 20, 22. Besides voice input, the input may also come from a mobile computing device which transmits commands over a network to the controller(s). When using a mobile computing device, a user interface of an application may include controls for a person/operator to select to adjust the patient turner. The application may also be programmed to receive voice input on the mobile computing device and transmit that voice input command to the controller(s). The communication link between the controller(s) and mobile computing device is bi-directional so that the controller(s) can provide feedback to the mobile computing device about operation of the patient turner. The person, such as a nurse, can thus turn/move a patient without physically having to do so. FIGS. 1-2 and 4-6 illustrate this functionality.

By way of example, when a command is given by an operator (e.g., a nurse) to raise a patient's head or upper body, as shown from FIG. 1 to FIG. 2, the controller(s) can affect one or more tether segments 24A, 26A to be lengthened or shortened (if embodied as, for example, a cable that can be automatically retracted or extended), which changes the inclination of the patient's head. Similar operation can be performed to raise the patient's feet, as needed. It will be appreciated by those with skill in the art that, as described above, this adjustment may also be done manually (e.g., if a carabiner-type linkage is employed). The presently described system can either maintain the patient 34 in this position, or it allows for wedges to be inserted under the patient for comfort and support.

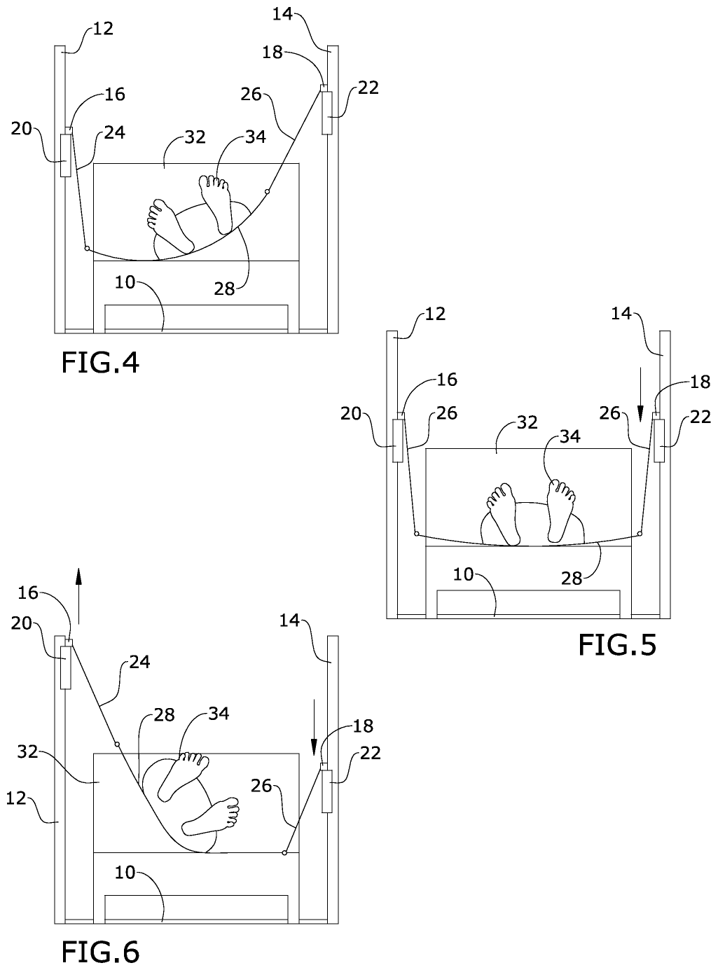

If a patient 34 needs to lay slightly on their right side, as shown in FIG. 4, the controller(s) causes the second linear actuator 22 to raise the second bearing 18 while maintaining the first bearing 16 in an intermediate position along the first post 12.

When a command is given by the operator to lay the patient 34 flat on the bed, as shown in FIG. 5, the controller(s) causes the second linear actuator 22 to lower the second bearing 18 to an intermediate position. In this position, the support rods are slightly elevated above the bed surface such that the sheet 28 is slightly raised on both sides, creating a more stable laying environment for the patient 34.

As shown in FIG. 6, when the patient 34 needs to be turned to lay substantially on their left side, the controller(s) causes the second linear actuator 22 to fully lower the second bearing 18 along the second post 14 and fully raise the first bearing 16 on the first post 12 via the first linear actuator 20.

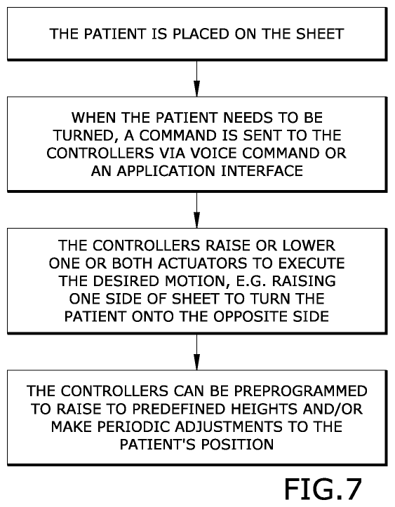

Other configurations of the patient turner are, of course, within the spirit and scope of the present disclosure. This operation can be done automatically via programming pre-determined intervals/times in which the patient 34 should be turned, or performed by the operator directly via voice command, input into the mobile computing device, and the like. FIG. 7 further summarizes the functionality of the present invention.

Embodiments of the present invention may be formed using any appropriate manufacturing technique and assembled as described above. For further example, the structure could mainly be made up of T-slot aluminum extrusions that are assembled together, with the other components (e.g., linear actuators, bearings, etc.) selected (depending on the overall system need), acquired, and coupled thereto.

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The computer system, that works in conjunction with the patient turner apparatus, and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system or run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

What is claimed is:

1. A patient turner system comprising:
a base frame configured to be positioned proximal a base of a patient bed;
a first post coupled to a first side of the base frame, the first post comprising a first track;
a second post coupled to a second side of the base frame, the second post comprising a second track;
a first bearing configured to move in the first track;
a second bearing configured to move in the second track;
a first actuator configured to move the first bearing;
a second actuator configured to move the second bearing;
a controller for selectively operating the first actuator and the second actuator; and
a sheet coupled to the first bearing at a sheet first side and coupled to the second bearing at a sheet second side, wherein movement of the first bearing, the second bearing, or both the first bearing and the second bearing adjusts a position of the sheet.

2. The patient turner system of claim 1, wherein the controller is configured to receive voice commands to selectively operate the first actuator and the second actuator.

3. The patient turner system of claim 1, further comprising a mobile computing device, wherein the mobile computing device is configured to transmit, over a communication link, commands to selectively operate the first actuator and the second actuator.

4. The patient turner system of claim 1, wherein the controller is configured to automatically operate the first actuator, the second actuator, or both the first actuator and the second actuator at pre-determined times.

5. The patient turner system of claim 1, wherein the first post is slidably coupled to a first track on the first side of the base frame and the second post is slidably coupled to a second track on the second side of the base frame.

6. The patient turner system of claim 1, wherein the first post and the second post each comprise uppermost ends that are neither directly supported by nor directly coupled to other structure.

7. The patient turner system of claim 1, wherein the first side of the sheet is coupled to the first bearing via a first plurality of flexible attachments directly coupled to the first side of the sheet, a first support rod directly coupled to the first plurality of flexible attachments, and a first tether directly coupled to the first support rod and to the first bearing.

8. The patient turner system of claim 7, wherein the first plurality of flexible attachments are detachably coupled to the first support rod.

9. The patient turner system of claim 7, wherein the first tether is adjustable in length.

10. A patient turner system in combination with a patient bed, the patient turner system comprising:
a base frame positioned proximal a base of the patient bed;
a first post coupled to a first side of the base frame, the first post comprising a first track;
a second post coupled to a second side of the base frame, the second post comprising a second track;
a first bearing configured to move in the first track;
a second bearing configured to move in the second track;
a first actuator configured to move the first bearing;
a second actuator configured to move the second bearing;
a controller for selectively operating the first actuator and the second actuator; and
a sheet coupled to the first bearing at a sheet first side and coupled to the second bearing at a sheet second side, wherein movement of the first bearing, the second bearing, or both the first bearing and the second bearing adjusts a position of the sheet.

11. The patient turner system in combination with the patient bed of claim 10, wherein the controller is configured to receive voice commands to selectively operate the first actuator and the second actuator.

12. The patient turner system in combination with the patient bed of claim 10, wherein the patient turner system further comprises a mobile computing device, wherein the mobile computing device is configured to transmit, over a communication link, commands to selectively operate the first actuator and the second actuator.

13. The patient turner system in combination with the patient bed of claim 10, wherein the first post is slidably coupled to the first side of the base frame and the second post is slidably coupled to the second side of the base frame.

14. The patient turner system in combination with the patient bed of claim 10, wherein the first side of the sheet is coupled to the first bearing via a first plurality of flexible attachments directly coupled to the first side of the sheet, a first support rod directly coupled to the first plurality of flexible attachments, and a first tether directly coupled to the first support rod and to the first bearing.

15. The patient turner system in combination with the patient bed of claim 10, wherein the sheet is positioned over an upper surface of the patient bed.
